(19) United States
(12) Patent Application Publication
(10) Pub. No.: US 2026/0091831 A1
(43) Pub. Date: Apr. 2, 2026

(54) VEHICLE REAR STRUCTURE

(71) Applicant: SUBARU CORPORATION, Tokyo (JP)

(72) Inventor: Hiroshi SHIMAKATA, Tokyo (JP)

(73) Assignee: SUBARU CORPORATION, Tokyo (JP)

(21) Appl. No.: 19/338,147

(22) Filed: Sep. 24, 2025

(30) Foreign Application Priority Data
Sep. 30, 2024 (JP) 2024-170401

(51) Int. Cl. B62D 35/00

(52) U.S. Cl. CPC B62D 35/007

(57) ABSTRACT

A vehicle rear structure is disposed on a rear portion of a vehicle body to produce an aerodynamic effect. The vehicle rear structure includes a rear spoiler and a vehicle-side facing member. The rear spoiler is a member extending in a width direction of the vehicle body. The vehicle-side facing member is disposed on the vehicle body side and is configured to face the rear spoiler and to protrude toward the rear spoiler.

### CROSS-REFERENCE TO RELATED APPLICATIONS

The present application claims priority from Japanese Patent Application No. 2024-170401 filed on Sep. 30, 2024, the entire contents of which are hereby incorporated by reference.

### BACKGROUND OF THE INVENTION

### Field of the Invention

The disclosure relates to a vehicle rear structure.

### Description of Background Art

Japanese Unexamined Utility Model (Registration) Application Publication (JP-UM-A) No. H04-99182 describes an example of a rear spoiler. The entire contents of this publication are incorporated herein by reference.

### SUMMARY OF THE INVENTION

According to one aspect of the present invention, a vehicle rear structure for producing an aerodynamic effect includes a rear spoiler that extends in a width direction of a vehicle body, and a vehicle-side facing member that is positioned on a vehicle body side and faces the rear spoiler such that the vehicle-side facing member protrudes toward the rear spoiler.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a side view illustrating a vehicle including a vehicle rear structure according to an embodiment of the disclosure;

FIG. 2 is a perspective view illustrating a rear portion of the vehicle including the vehicle rear structure according to the embodiment of the disclosure;

FIG. 3 is a sectional view illustrating the vehicle rear structure according to the embodiment of the disclosure;

FIG. 4 is a graph illustrating the effect of the vehicle rear structure according to the embodiment of the disclosure;

FIG. 5A illustrates the aerodynamic effect of a comparative example; and

FIG. 5B illustrates the aerodynamic effect of the embodiment of the disclosure.

### DETAILED DESCRIPTION OF THE EMBODIMENTS

Embodiments will now be described with reference to the accompanying drawings, wherein like reference numerals designate corresponding or identical elements throughout the various drawings.

Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis.

A vehicle rear structure 10 and a vehicle 11 according to embodiments of the present invention will be described in detail with reference to the drawings. Forward, rearward, upward, downward, leftward, and rightward directions will be used in the following description. Leftward and rightward are leftward and rightward when the vehicle rear structure 10 is seen from the front.

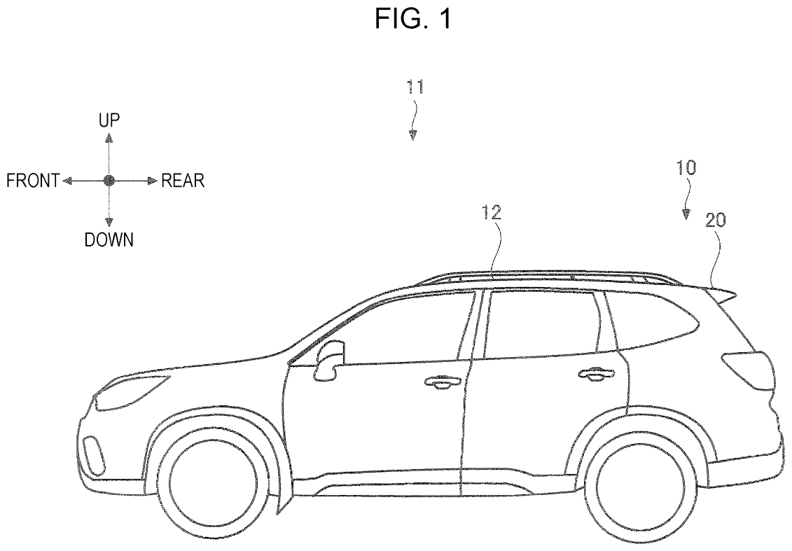

FIG. 1 is a side view illustrating the vehicle 11 including the vehicle rear structure 10.

The vehicle 11 is, for example, an engine car, a battery electric vehicle (BEV), a hybrid electric vehicle (HEV), a plug-in hybrid electric vehicle (PHEV), or the like. The vehicle 11 may be a passenger car, an SUV, a van, or the like.

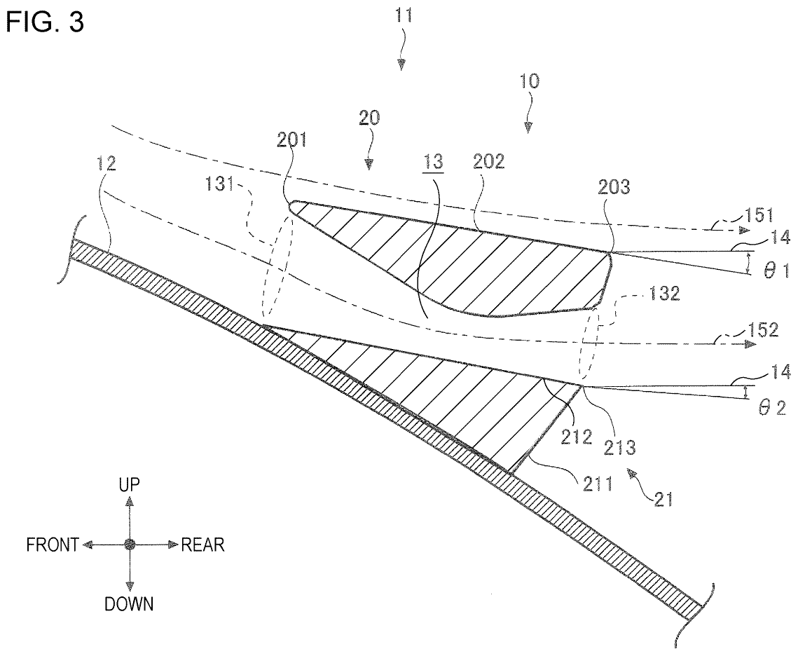

The vehicle rear structure 10 is disposed on a vehicle body 12 of the vehicle 11. The vehicle rear structure 10 is a structure disposed at an upper rear end of the vehicle body 12 to produce an aerodynamic effect. With the present embodiment, aerodynamic performance is improved by having the vehicle rear structure 10, and energy saving during traveling of the vehicle 11 is realized. These facts will be described below with reference to FIG. 3 and other figures.

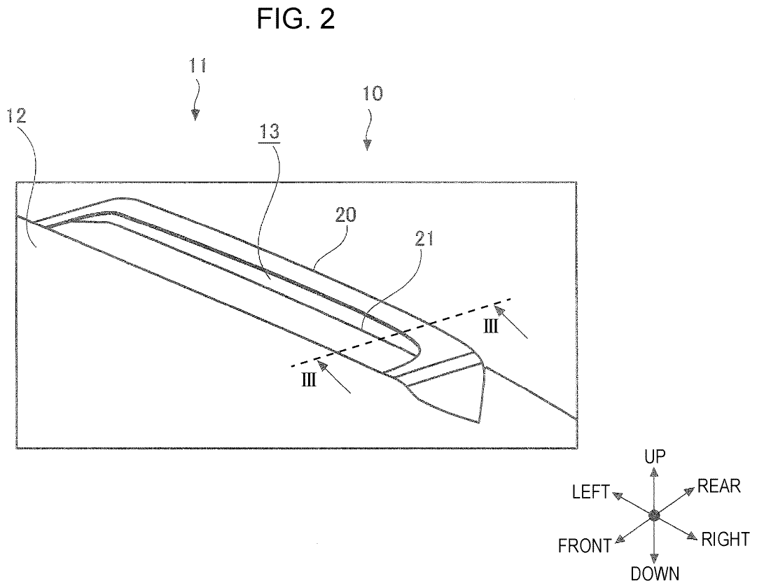

FIG. 2 is a perspective view illustrating a rear portion of the vehicle 11 including the vehicle rear structure 10.

A rear spoiler 20 is a member extending in the width direction of the vehicle body 12. Here, the rear spoiler 20 has a main surface facing in the up-down direction and extends continuously from the left end to the right end of the vehicle body 12. As described below, a vehicle-side facing member 21 is disposed on the vehicle body 12 in the vicinity of the rear spoiler 20. Moreover, a hollow 13 is formed between the rear spoiler 20 and the vehicle-side facing member 21. Here, the hollow 13 may be a space that is integrally and continuously formed from the right end to the left end of the vehicle body 12. Further, the hollow 13 may be a space that is divided into multiple spaces in the left-right direction.

FIG. 3 is a sectional view illustrating the vehicle rear structure 10. FIG. 3 is a sectional view taken along line III-III in FIG. 2. Here, the section taken along line III-III is a section including the front-back direction and the up-down direction.

The vehicle rear structure 10 is a structure that includes the rear spoiler 20 and the vehicle-side facing member 21 and produces an aerodynamic effect. The vehicle rear structure 10 is disposed, for example, on an upper end portion at the rear end of the vehicle body 12.

As described above, the rear spoiler 20 is an aerodynamic member that is disposed above the vehicle body 12. The rear spoiler 20 mainly includes a spoiler body 201, a spoiler upper surface 202, and a spoiler rear end portion 203. The spoiler body 201 is made of synthetic resin plates combined into a predetermined shape and has a hollow structure for weight reduction. The spoiler upper surface 202, which is the upper surface of the rear spoiler 20, is an upper surface portion of the spoiler body 201, and is an inclined surface that has a substantially flat shape and is inclined downward and rearward. The spoiler rear end portion 203 is a rear end portion of the spoiler body 201.

The vehicle-side facing member 21 is a member disposed on the vehicle body 12 side. The vehicle-side facing member 21 is configured to face the rear spoiler 20 and to protrude toward the rear spoiler 20. For example, the vehicle-side facing member 21 mainly includes a facing member body 211, a facing member upper surface 212, and a facing member rear end portion 213. The facing member body 211 is made of a synthetic resin plate having a predetermined shape and has a hollow structure. The facing member upper surface 212, which is an upper surface of the facing member body 211, is an inclined surface that has a substantially flat shape and is inclined downward and rearward. The facing member rear end portion 213 is a rear end portion of the facing member body 211.

The hollow 13 is a space formed between the rear spoiler 20 and the vehicle-side facing member 21. A front-side opening 131 is formed on the front end side of the hollow 13, and a rear-side opening 132 is formed on the rear end side of the hollow 13. In the present embodiment, the area of the rear-side opening 132 is smaller than the area of the front-side opening 131.

A first angle θ1 is defined as the angle between the spoiler upper surface 202, which is the upper surface of the rear spoiler 20, and a horizontal plane 14. Here, the first angle θ1 is an angle that is inclined downward. A second angle θ2 is defined as the angle between the facing member upper surface 212, which is the upper surface of the vehicle-side facing member 21, and the horizontal plane 14. Here, the second angle θ2 is an angle that is inclined downward.

In this case, the first angle θ1 is larger than the second angle θ2. In other words, the facing member upper surface 212 is a surface that is closer to horizontal than the spoiler upper surface 202. With such a configuration, as described below, second airflow 152 that flows over the facing member upper surface 212 has an effective influence on first airflow 151 that flows over the spoiler upper surface 202.

The facing member rear end portion 213, which is a rear end portion of the vehicle-side facing member 21, is disposed further forward than the spoiler rear end portion 203, which is a rear end portion of the rear spoiler 20. With such a configuration, as described below, the second airflow 152 that passes the facing member rear end portion 213 has an effective influence on the first airflow 151 that passes the spoiler rear end portion 203.

Next, referring to FIG. 3, the function of the vehicle rear structure 10, having the configuration described above, when the vehicle 11 travels will be described.

First, when the vehicle 11 travels, traveling airflow is generated around the vehicle body 12. A part of traveling airflow passes the vehicle rear structure 10 and the periphery thereof. Here, first airflow 151 is defined as traveling airflow that flows along the spoiler upper surface 202 of the rear spoiler 20. Second airflow 152 is traveling airflow that passes through the hollow 13 of the vehicle rear structure 10, that is, traveling airflow that flows over the facing member upper surface 212 of the vehicle-side facing member 21.

In the present embodiment, the vehicle-side facing member 21 is configured to protrude toward the rear spoiler 20 at a position facing the rear spoiler 20. Thus, when the vehicle 11 travels, the second airflow 152, which is traveling airflow, effectively passes through the hollow 13, which is a space between the vehicle-side facing member 21 and the rear spoiler 20. Here, in view of the law of conservation of mass of fluids, the second airflow 152, which flows through the vicinity of the vehicle-side facing member 21, has a higher velocity than the first airflow 151, which flows along the spoiler upper surface 202. Thus, the second airflow 152 pulls the first airflow 151 downward, and the air resistance coefficient of the vehicle body 12 when the vehicle travels decreases. That is, it is possible to reduce a dead water region formed on the rear surface of the vehicle body 12 and to reduce energy used for vehicle traveling.

Moreover, as described above, the spoiler upper surface 202 of the rear spoiler 20 is further inclined downward and rearward than the facing member upper surface 212 of the vehicle-side facing member 21. With such a configuration, the first airflow 151 that flows along the spoiler upper surface 202 of the rear spoiler 20 flows in such a way as to be inclined downward and rearward. On the other hand, the second airflow 152 that flows over the facing member upper surface 212 of the vehicle-side facing member 21 flows rearward at a high velocity at an angle closer to horizontal than the first airflow 151. Thus, the flow velocity of the second airflow 152 that flows along the facing member upper surface 212 is far higher than the flow velocity of the first airflow 151 that flows along the spoiler upper surface 202. Therefore, the first airflow 151 is pulled downward due to a large pressure difference between the second airflow 152 and the first airflow 151. Accordingly, the first airflow 151 smoothly flows downward, and it is possible to reduce air resistance. Moreover, because the facing member upper surface 212 of the vehicle-side facing member 21 is inclined downward and rearward, the aforementioned effect produced by the second airflow 152 is noticeable.

In the hollow 13, the area of the rear-side opening 132 is smaller than the area of the front-side opening 131. With such a configuration, traveling airflow entered from the front-side opening 131 becomes contracted flow by being compressed into the hollow 13, and is released rearward, as the second airflow 152 having a high velocity, from the rear-side opening 132. Thus, it is possible to make the flow velocity of the second airflow 152, which is released rearward from the rear-side opening 132, higher than the flow velocity of the first airflow 151 that flows upstream of the rear spoiler 20. Therefore, the first airflow 151 is pulled downward due to the pressure difference between the second airflow 152 and the first airflow 151. Thus, the first airflow 151 smoothly flows downward, and it is possible to further reduce air resistance.

Moreover, as described above, the facing member rear end portion 213 of the vehicle-side facing member 21 is disposed further forward than the spoiler rear end portion 203 of the spoiler upper surface 202. Thus, it is possible to extend a region in which the second airflow 152, which passes the vehicle-side facing member 21, influences the first airflow 151, which flows over the spoiler upper surface 202, and it is possible to make the effect of reducing air resistance noticeable.

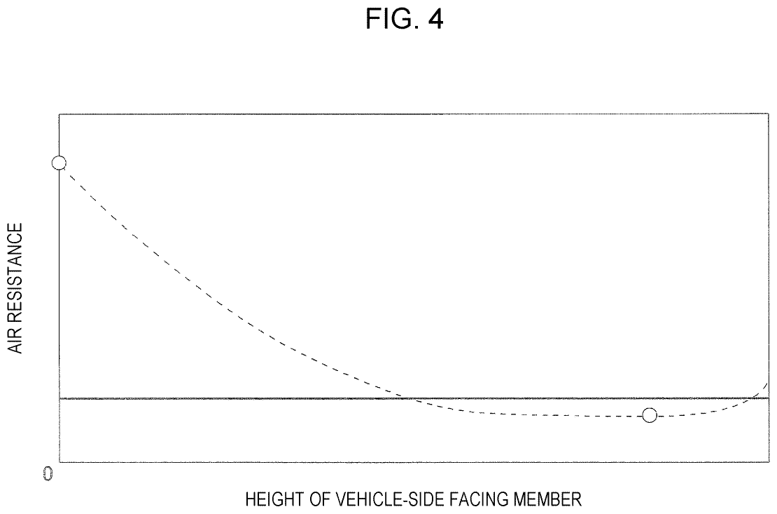

FIG. 4 is a graph illustrating the effect of the vehicle rear structure 10. In this graph, the horizontal axis represents the height to which the vehicle-side facing member 21 protrudes from the surface of the vehicle body 12. The vertical axis represents the ratio between air resistance generated when the vehicle 11 having the vehicle rear structure 10 travels and air resistance generated when a vehicle not having the vehicle-side facing member 21 travels. Air resistance increases upward along the vertical axis, and air resistance decreases downward along the vertical axis. In FIG. 4, the dotted line represents the air resistance of a vehicle having the vehicle rear structure 10 according to the present embodiment, and the solid line represents the air resistance of an existing vehicle.

Referring to FIG. 4, as the height to which the vehicle-side facing member 21 protrudes from the surface of the vehicle body 12 increases, air resistance decreases. This is because, as described above with reference to FIG. 3, as the protruding height of the vehicle-side facing member 21 increases, the second airflow 152 that passes the facing member upper surface 212 of the vehicle-side facing member 21 greatly interferes with the first airflow 151 that passes the spoiler upper surface 202 of the rear spoiler 20.

Until the height to which the vehicle-side facing member 21 protrudes from the surface of the vehicle body 12 becomes a predetermined value, air resistance decreases in accordance with the protruding height of the vehicle-side facing member 21. On the other hand, when the height to which the vehicle-side facing member 21 protrudes from the surface of the vehicle body 12 becomes larger than a predetermined value, the air resistance becomes substantially constant at a value lower than the air resistance of a vehicle not having the vehicle-side facing member 21. When the height to which the vehicle-side facing member 21 protrudes from the surface of the vehicle body 12 increases further, air resistance increases. Thus, in the present embodiment, in consideration of the appearance design of the vehicle 11 and the relationship with the other constituent members, the height to which the vehicle-side facing member 21 protrudes from the surface of the vehicle body 12 is determined in a range such that the air resistance becomes substantially constant.

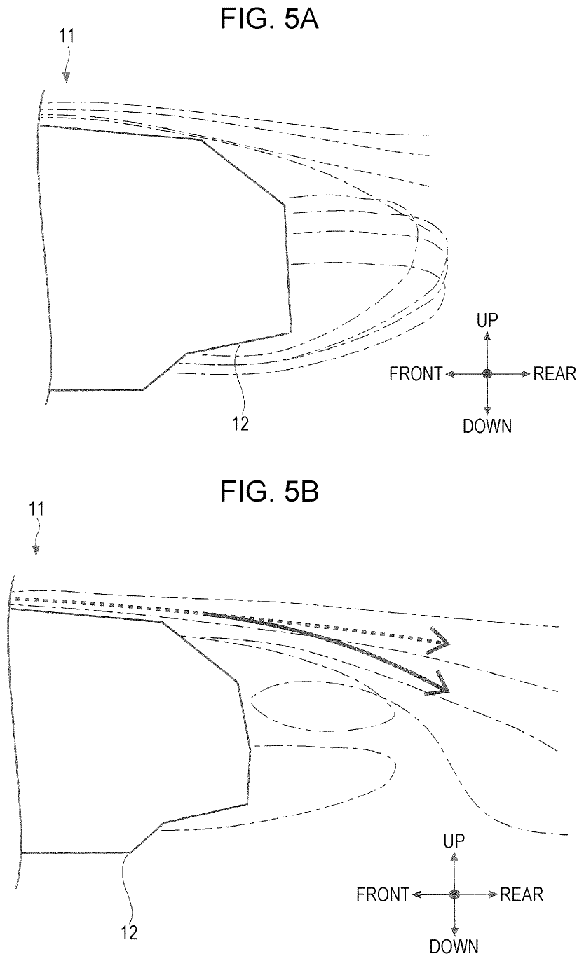

FIG. 5A illustrates the aerodynamic effect of a comparative example. Here, the chain lines represent the flow of traveling airflow when the vehicle 11 not having the vehicle rear structure 10 according to the present embodiment travels. As can be clearly seen from FIG. 5A, without the vehicle-side facing member 21, convolution of traveling airflow particularly from below is large in the vicinity of the rear surface of the vehicle body 12. Thus, air resistance when the vehicle 11 travels increases, and energy consumption during traveling increases.

FIG. 5B illustrates the aerodynamic effect of the vehicle rear structure 10 according to the present embodiment. Here, the chain lines represent the flow of traveling airflow when the vehicle 11 having the vehicle rear structure 10 including the vehicle-side facing member 21 illustrated in FIG. 3 travels. The thick solid line represents the flow direction of traveling airflow on the upper rear side of the vehicle body 12, and the thick broken line represents the flow direction of traveling airflow when a vehicle not having the vehicle-side facing member 21 illustrated in FIG. 3 travels. As can be clearly seen from FIG. 5B, when the vehicle rear structure 10 illustrated in FIG. 3 is disposed on a rear upper end portion the vehicle body 12, the flow direction of traveling airflow on the upper rear side of the vehicle body 12 moves downward, convolution of traveling airflow from downward decreases, the air resistance of the vehicle rear structure 10 during traveling is reduced, and energy consumption during traveling can be reduced.

If the vehicle 11 does not include the vehicle-side facing member 21 illustrated in FIG. 3 and only has the rear spoiler 20, convolution of traveling airflow in the vicinity of the vehicle body 12 particularly from upward increases, air resistance during traveling of the vehicle 11 increases, and energy consumption during traveling increases.

By having the vehicle-side facing member 21, separation of traveling airflow in the vicinity of a rear surface of the vehicle body 12 is promoted, and it becomes possible to reduce convolution of traveling airflow particularly from upward in the vicinity of the rear surface of the vehicle body 12. By having both of the rear spoiler 20 and the vehicle-side facing member 21 as the vehicle rear structure 10 according to the present embodiment does, convolution of traveling airflow from upward and downward in the vicinity of the rear surface of the vehicle body 12 is reduced, the air resistance of the vehicle rear structure 10 during traveling is reduced, and energy consumption during traveling can be reduced.

Hereafter, technical ideas that can be grasped from the present embodiment described above and their advantageous effects will be described.

A vehicle rear structure according to an embodiment of the disclosure is a vehicle rear structure disposed on a rear portion of a vehicle body to produce an aerodynamic effect. The vehicle rear structure includes a rear spoiler and a vehicle-side facing member. The rear spoiler is a member extending in a width direction of the vehicle body. The vehicle-side facing member is a member disposed on the vehicle body side and is configured to face the rear spoiler and to protrude toward the rear spoiler. With the vehicle rear structure according to the embodiment of the disclosure, because the vehicle-side facing member protrudes toward the rear spoiler at a position facing the rear spoiler, traveling airflow effectively passes through a space between the vehicle-side facing member and the rear spoiler when the vehicle travels. Thus, the air resistance coefficient of the vehicle body when the vehicle travels decreases, and it is possible to reduce energy used for vehicle traveling. Moreover, it is possible to make the effect of aerodynamic improvement due to the rear spoiler noticeable without considerably extending the rear spoiler downward.

In a vehicle rear structure according to an embodiment of the disclosure, when a first angle is defined as an angle between an upper surface of the rear spoiler and a horizontal plane and a second angle is defined as an angle between an upper surface of the vehicle-side facing member and the horizontal plane, the first angle is larger than the second angle. With the vehicle rear structure according to the embodiment of the disclosure, the upper surface of the rear spoiler is further inclined downward and rearward than the upper surface of the vehicle-side facing member. Thus, when first airflow is defined as airflow that flows over the upper surface of the rear spoiler and second airflow is defined as airflow that flows over the upper surface of the vehicle-side facing member, the flow velocity of the second airflow is higher than the flow velocity of the first airflow. Thus, the first airflow is pulled downward due to a negative pressure generated between the second airflow and the first airflow. Therefore, the first airflow smoothly flows downward, and it is possible to reduce air resistance.

In a vehicle rear structure according to an embodiment of the disclosure, the upper surface of the vehicle-side facing member is an inclined surface that is inclined downward and rearward. With the vehicle rear structure according to the embodiment of the disclosure, because the upper surface of the vehicle-side facing member is inclined downward and rearward, it is possible to make the effect produced by the second airflow noticeable.

In a vehicle rear structure according to an embodiment of the disclosure, a hollow is formed between the rear spoiler and the vehicle-side facing member, a front-side opening is formed on a front end side of the hollow, a rear-side opening is formed on a rear end side of the hollow, and an area of the rear-side opening is smaller than an area of the front-side opening. With the vehicle rear structure according to the embodiment of the disclosure, because the area of the rear-side opening is smaller than the area of the front-side opening, it is possible to make the flow velocity of air that is released rearward from the rear-side opening higher than the flow velocity of air that enters from the front-side opening. Here, when first airflow is defined as airflow that flows over the upper surface of the rear spoiler and second airflow is defined as airflow that flows over the upper surface of the vehicle-side facing member, it is possible to make the flow velocity of the second airflow that is released rearward from the rear-side opening higher than the flow velocity of the first airflow that flows upstream of the rear spoiler. Thus, the first airflow is pulled downward due to a negative pressure generated between the second airflow and the first airflow. Therefore, the first airflow smoothly flows downward, and it is possible to reduce air resistance.

In a vehicle rear structure according to an embodiment of the disclosure, a rear end portion of the vehicle-side facing member is disposed further forward than a rear end portion of the rear spoiler. With the vehicle rear structure according to the embodiment of the disclosure, it is possible to increase the influence of airflow that passes the rear end portion of the vehicle-side facing member on airflow that passes the upper surface of the rear spoiler, and it is possible to make the effect of reducing air resistance noticeable.

The disclosure is not limited to the embodiments and may be modified within the gist of the disclosure. The configurations described above may be combined with each other.

A rear spoiler is attached to a rear end portion of a vehicle to improve the aerodynamic performance of the vehicle. For example, a rear spoiler is a substantially plate-shaped member attached to a rear end portion of a vehicle and extends in the width direction of the vehicle. By attaching a rear spoiler to a vehicle, a dead water region on the rear surface of the vehicle is reduced, and the air resistance of the vehicle is reduced.

Japanese Unexamined Utility Model (Registration) Application Publication (JP-UM-A) No. H04-99182 describes an example of a rear spoiler. An attachment body of the rear spoiler described in JP-UM-A No. H04-99182 has a substantially triangular shape in a sectional side view and has a hollow inside. The attachment body has a substantially horizontal upper surface, an attachment surface extending rearward and downward from a front end of the upper surface, and a rear lower surface extending forward and downward from a rear end of the upper surface. A rear portion of the upper surface is a spoiler element that bulges upward and guides airflow against the upper surface rearward and upward. The attachment surface is a curved surface protruding inward into the attachment body and is attached substantially along a surface of a vehicle body wall by using a screw. The rear spoiler is made from a synthetic resin or the like to have a hollow inside, and an upper surface thereof is a spoiler element that guides airflow against the upper surface rearward and upward. The rear spoiler can be raised and lowered relative to the attachment body by using a spoiler raising/lowering mechanism, and a lower surface of the rear spoiler becomes close to the upper surface when the rear spoiler is lowered. With such a configuration, it is possible to attach the rear spoiler to a vehicle body wall that is substantially upright or inclined rearward.

The disclosure described in JP-UM-A No. H04-99182 has room for improvement in view of further improvement of aerodynamic performance.

For example, a rear end of a rear spoiler is lowered to improve the aerodynamic performance of the spoiler. This is effective for, for example, an SUV, a van, and the like. However, lowering a rear end of a rear spoiler may obstruct the rear view depending on the angle of a rear window or the like. Moreover, lowering a rear end of a rear spoiler may reduce a space where peripheral components are to be placed. Furthermore, lowering a rear end of a rear spoiler greatly affects the form and silhouette of the vehicle. From these facts, there is a limit on lowering of a rear end of a rear spoiler.

It is desirable to provides a vehicle rear structure that can further improve the aerodynamic performance due to a rear spoiler.

An aspect of the disclosure provides a vehicle rear structure disposed on a rear portion of a vehicle body to produce an aerodynamic effect. The vehicle rear structure includes a rear spoiler and a vehicle-side facing member. The rear spoiler is a member extending in a width direction of the vehicle body. The vehicle-side facing member is disposed on the vehicle body side, and is configured to face the rear spoiler and to protrude toward the rear spoiler.

Obviously, numerous modifications and variations of the present invention are possible in light of the above teachings. It is therefore to be understood that within the scope of the appended claims, the invention may be practiced otherwise than as specifically described herein.

1. A vehicle rear structure for producing an aerodynamic effect, comprising:
a rear spoiler configured to extend in a width direction of a vehicle body; and
a vehicle-side facing member configured to be positioned on a vehicle body side and face the rear spoiler such that the vehicle-side facing member protrudes toward the rear spoiler.

2. The vehicle rear structure according to claim 1, wherein the rear spoiler and vehicle-side facing member are formed such that a first angle between an upper surface of the rear spoiler and a horizontal plane is larger than a second angle between an upper surface of the vehicle-side facing member and the horizontal plane.

3. The vehicle rear structure according to claim 2, wherein the upper surface of the vehicle-side facing member is an inclined surface inclined downward and rearward.

4. The vehicle rear structure according to claim 1, wherein the rear spoiler and vehicle-side facing member are formed such that a hollow is formed between the rear spoiler and the vehicle-side facing member and has a front-side opening on a front end side of the hollow and a rear-side opening on a rear end side of the hollow and that an area of the rear-side opening is smaller than an area of the front-side opening.

5. The vehicle rear structure according to claim 1, wherein the vehicle-side facing member has a rear end portion formed further forward than a rear end portion of the rear spoiler.

6. The vehicle rear structure according to claim 2, wherein the rear spoiler and vehicle-side facing member are formed such that a hollow is formed between the rear spoiler and the vehicle-side facing member and has a front-side opening on a front end side of the hollow and a rear-side opening on a rear end side of the hollow and that an area of the rear-side opening is smaller than an area of the front-side opening.

7. The vehicle rear structure according to claim 2, wherein the vehicle-side facing member has a rear end portion formed further forward than a rear end portion of the rear spoiler.

8. The vehicle rear structure according to claim 3, wherein the rear spoiler and vehicle-side facing member are formed such that a hollow is formed between the rear spoiler and the vehicle-side facing member and has a front-side opening on a front end side of the hollow and a rear-side opening on a rear end side of the hollow and that an area of the rear-side opening is smaller than an area of the front-side opening.

9. The vehicle rear structure according to claim 3, wherein the vehicle-side facing member has a rear end portion formed further forward than a rear end portion of the rear spoiler.

10. The vehicle rear structure according to claim 4, wherein the vehicle-side facing member has a rear end portion formed further forward than a rear end portion of the rear spoiler.

11. The vehicle rear structure according to claim 8, wherein the vehicle-side facing member has a rear end portion formed further forward than a rear end portion of the rear spoiler.
